(19) United States
(12) Patent Application Publication
(10) Pub. No.: US 2018/0141569 A1
(43) Pub. Date: May 24, 2018

(54) VEHICLE CONTROL SYSTEM, VEHICLE CONTROL METHOD, AND VEHICLE CONTROL PROGRAM

(71) Applicant: HONDA MOTOR CO., LTD., Tokyo (JP)

(72) Inventors: Kentaro Ishisaka, Utsunomiya-shi (JP); Yoshitaka Mimura, Utsunomiya-shi (JP)

(21) Appl. No.: 15/817,482

(22) Filed: Nov. 20, 2017

(30) Foreign Application Priority Data
Nov. 22, 2016 (JP) 2016-227250

(51) Int. Cl. B60W 50/08; B60W 50/14

(52) U.S. Cl. CPC B60W 50/085; B60W 2050/0067; B60W 50/14

(57) ABSTRACT

A vehicle control system includes: a travel assist control unit that performs an event which relates to a travel assist control of a vehicle; an interface unit that accepts an operation of an occupant of the vehicle and displays an image; and an interface control unit that controls the interface unit so as to present a menu which enables a change of setting by the occupant of the vehicle in relation to an event which is being performed by the travel assist control unit.

### CROSS-REFERENCE TO RELATED APPLICATION

Priority is claimed on Japanese Patent Application No. 2016-227250, filed on Nov. 22, 2016, the contents of which are incorporated herein by reference.

### BACKGROUND

### Field of the Invention

The present invention relates to a vehicle control system, a vehicle control method, and a vehicle control program.

### Background

In recent years, research has been conducted on techniques that allow a vehicle to travel according to automated driving along a travel schedule route for arriving at a destination. In relation to this, automated driving assist systems have been disclosed in which a suspension zone where an automated driving control is not performed is set, in response to an operation of a user, for an automated driving zone included in a travel schedule route, and automated driving is performed in a zone except the set suspension zone (for example, refer to Japanese Patent Application, Publication No. 2015-141478A).

### SUMMARY

However, in the related art, there may be a case in which it is impossible to perform a flexible change of setting while performing automated driving or while performing travel assist other than automated driving.

An object of an aspect of the present invention is to provide a vehicle control system, a vehicle control method, and a vehicle control program capable of guiding a user so as to easily perform a change of setting relating to travel assist.

(1) A vehicle control system according to an aspect of the present invention includes: a travel assist control unit that performs an event which relates to a travel assist control of a vehicle; an interface unit that accepts an operation of an occupant of the vehicle and displays an image; and an interface control unit that controls the interface unit so as to present a menu which enables a change of setting by the occupant of the vehicle in relation to an event which is being performed by the travel assist control unit.

(2) In the above vehicle control system, in a case where the event which is being performed by the travel assist control unit is a specific event, when accepting a command to cancel performing the specific event, the interface control unit may command the travel assist control unit to cancel performing the event.

(3) In the above vehicle control system, in a case where there is an event for which a change of setting by the occupant is accepted a plurality of times, the interface control unit may inquire the occupant about whether or not set information of the event is to be changed using the interface unit.

(4) In the above vehicle control system, the interface control unit may cause the interface unit to present information relating to at least one of a remaining time and a remaining distance in which a change of setting can be made by the occupant of the vehicle regarding the event which is being performed by the travel assist control unit.

(5) Another aspect of the present invention is a vehicle control method, by way of an in-vehicle computer, including: performing an event which relates to a travel assist control of a vehicle; accepting an operation of an occupant of the vehicle and displaying an image on an interface unit; and controlling the interface unit so as to present a menu which enables a change of setting by the occupant of the vehicle in relation to an event which is being performed.

(6) Still another aspect of the present invention is a non-transitory computer-readable recording medium including a vehicle control program that causes an in-vehicle computer to: perform an event which relates to a travel assist control of a vehicle; accept an operation of an occupant of the vehicle and display an image on an interface unit; and control the interface unit so as to present a menu which enables a change of setting by the occupant of the vehicle in relation to an event which is being performed.

According to the configurations (1), (2), (5), and (6) described above, it is possible to guide an occupant so as to easily perform a change of setting relating to travel assist.

According to the configuration (3) described above, by responding to the inquiry about whether or not the set information is to be changed, the occupant can customize travel assist corresponding to the preference of each occupant.

According to the configuration (4) described above, the occupant can further clearly understand the timing in which the displayed event can be canceled and can determine the necessity of performing the event and the like easily within a period of time in which the displayed event can be canceled.

### BRIEF DESCRIPTION OF THE DRAWINGS

FIG. 1 is a configuration view of a vehicle system in a first embodiment.

FIG. 2 is a view showing a state in which a relative position and an attitude of a vehicle with respect to a travel lane are recognized by a vehicle position recognition unit.

FIG. 3 is a view showing a state in which a target trajectory is generated based on a recommended lane.

FIG. 4 is a view showing an example of a display screen that is presented on a touch panel by a control of an interface control unit.

FIG. 5 is a view showing an example of a menu screen that is displayed on the touch panel.

FIG. 6 is a view showing an example of a set information table.

FIG. 7 is a view showing an example of a real-time change-accepting screen that is displayed when performing an event.

FIG. 8 is a view showing an example of a target trajectory that is generated by an action plan generation unit when a lane change event which is being performed is canceled.

FIG. 9 is a view showing an example of a display screen when the lane change event is canceled.

FIG. 10 is a view showing an example of change history information.

FIG. 11 is a view showing an example of a screen for inquiring about whether or not set information of the event is updated.

FIG. 12 is a flowchart showing an example of a vehicle control process of the first embodiment.

FIG. 13 is a configuration view of a vehicle system 2 of a second embodiment.

### DESCRIPTION OF THE EMBODIMENTS

Hereinafter, a vehicle control system, a vehicle control method, and a vehicle control program according to an embodiment of the present invention will be described with reference to the drawings.

### First Embodiment

First, a vehicle control system, a vehicle control method, and a vehicle control program according to a first embodiment are described. In the first embodiment, the vehicle control system is applied to an automated driving vehicle. The automated driving refers to, for example, controlling automatically at least one of acceleration/deceleration and steering of a vehicle to allow the vehicle to travel. A control (automated driving control) for automated driving in the first embodiment is an example of a travel assist control.

[Entire Configuration]

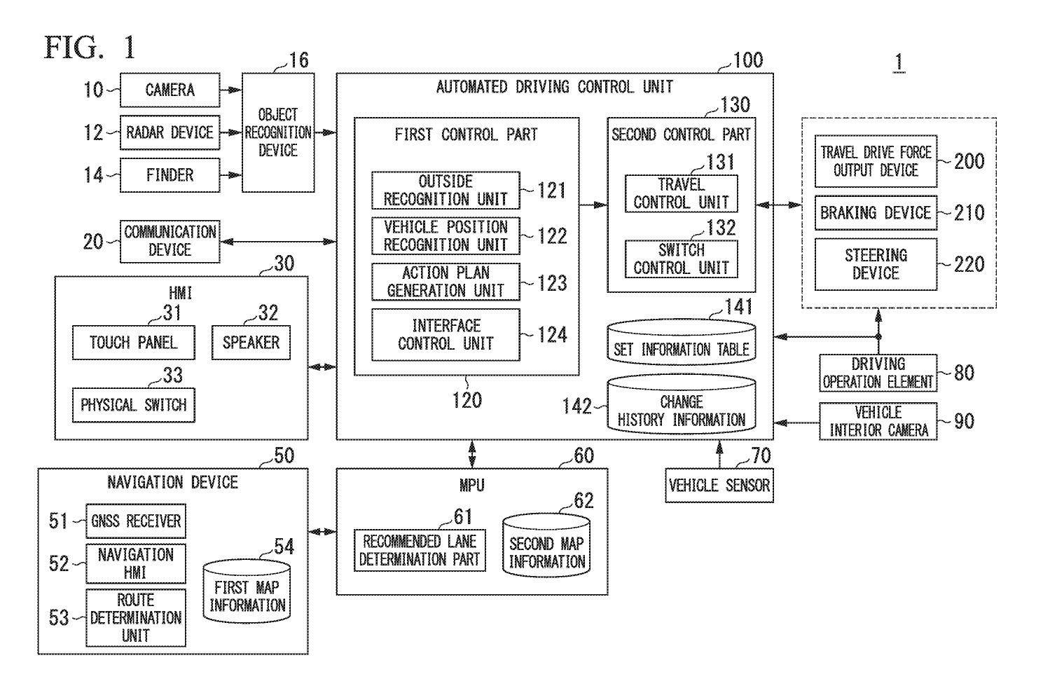

FIG. 1 is a configuration view of a vehicle system 1 of the first embodiment. A vehicle (hereinafter, referred to as a “vehicle M”) on which the vehicle system 1 is provided is, for example, a vehicle having two wheels, three wheels, four wheels, or the like. A drive source of the vehicle on which the vehicle system 1 is provided is an internal combustion engine such as a diesel engine and a gasoline engine, an electric motor, or the combination of the internal combustion engine and the electric motor. The electric motor is operated by using a generated electric power by a generator that is connected to the internal combustion engine or a discharged electric power of a secondary battery or a fuel cell.

The vehicle system 1 includes, for example, a camera 10, a radar device 12, a finder 14, an object recognition device 16, a communication device 20, a HMI (Human Machine Interface) 30, a navigation device 50, a MPU (Micro-Processing Unit) 60, a vehicle sensor 70, a driving operation element 80, a vehicle interior camera 90, an automated driving control unit 100, a travel drive force output device 200, a braking device 210, and a steering device 220. These devices and equipment are mutually connected by a multiplex communication line such as a CAN (Controller Area Network) communication line, a serial communication line, a wireless communication network, and the like. The configuration shown in FIG. 1 is just an example. Part of the configuration may be omitted, and another configuration may be further added.

In the first embodiment, for example, a “vehicle control system” includes the HMI 30 and the automated driving control unit 100. The HMI 30 is an example of an “interface unit”.

The camera 10 is, for example, a digital camera that uses a solid-state imaging element such as a CCD (Charge-Coupled Device) or a CMOS (Complementary Metal Oxide Semiconductor). One or more cameras 10 are attached to an arbitrary part of the vehicle on which the vehicle system 1 is provided. When imaging the frontward direction, the camera 10 is attached to an upper part of a front window shield, a rear surface of a room mirror, and the like. When imaging the rearward direction, the camera 10 is attached to an upper part of a rear window shield, a rear door, and the like. When imaging the lateral direction, the camera 10 is attached to a door mirror and the like. For example, the camera 10 periodically and repeatedly captures an image of the vicinity of the vehicle M. The camera 10 may be a stereo camera.

The radar device 12 radiates radio waves such as millimeter waves to the vicinity of the vehicle M and detects the radio waves (reflected waves) reflected by an object to detect at least a position (distance and azimuth) of the object. One or more radar devices 12 are attached to an arbitrary part of the vehicle M. The radar device 12 may detect the position and the speed of the object by a FMCW (Frequency-Modulated Continuous Wave) method.

The finder 14 is a LIDAR (Light Detection and Ranging, or Laser Imaging Detection and Ranging) that measures scattered light with respect to irradiation light and that detects a distance to a target. One or more finders 14 are attached to an arbitrary part of the vehicle M.

The object recognition device 16 performs a sensor fusion process with respect to a detection result by part of or all of the camera 10, the radar device 12, and the finder 14 and recognizes the position, category, speed, and the like of the object. The object recognition device 16 outputs the recognition result to the automated driving control unit 100.

The communication device 20 communicates with another vehicle that is present in the vicinity of the vehicle M, for example, by using a cellular network, a Wi-Fi network, Bluetooth (registered trademark), DSRC (Dedicated Short-Range Communication), and the like or communicates with a variety of server apparatuses via a wireless base station.

The HMI 30 presents a variety of information to an occupant of the vehicle M and accepts an input operation by the occupant. The HMI 30 includes, for example, a touch panel 31, a speaker 32, and a physical switch 33. The physical switch 33 is an example of an “operation element”.

The touch panel 31 is a LCD (Liquid Crystal Display), an organic EL (Electro Luminescence) display device, and the like. The touch panel 31 includes, for example, a function of displaying an image and a function of accepting an approach position of a finger of an operator with respect to a display surface and an operation content. The touch panel 31 may be, for example, a HUD (Head-Up Display) that projects an image onto a front window shield or another window. The touch panel 31 may include a GUI (Graphical User Interface) switch. The HMI 30 may include a display device that is not the touch panel 31.

The speaker 32 outputs, for example, speech that corresponds to a content which is displayed on the touch panel 31 or outputs an alarm and the like.

The physical switch 33 is a mechanical switch or a switch that includes a capacitance sensor and that is other than the touch panel 31. The physical switch 33 is arranged at an arbitrary part in the vehicle M. For example, the physical switch 33 may be provided on a steering wheel or a spoke section of the steering wheel of the vehicle M or may be provided on a side part of a driver's seat or an armrest, or in the vicinity of the arrangement position of the touch panel 31. The physical switch 33 may be, for example, a cross key or may be a dial switch. The physical switch 33 is a switch that is different from an existing switch which is used for an operation relating to manual driving such as a winker lever and an on/off switch of a hazard lamp.

The physical switch 33 accepts, for example, a change of setting of each event in an automated driving control of the vehicle M in the first embodiment.

The navigation device 50 includes, for example, a GNSS (Global Navigation Satellite System) receiver 51, a navigation HMI 52, and a route determination unit 53. The navigation device 50 holds first map information 54 in a storage device such as a HDD (Hard Disk Drive) and a flash memory. The GNSS receiver 51 identifies the position of the vehicle M based on a signal that is received from the GNSS satellite. The position of the vehicle M may be identified or supplemented by an INS (Inertial Navigation System) that utilizes an output of the vehicle sensor 70. The navigation HMI 52 includes a display device, a speaker, a touch panel, a key, and the like. The navigation HMI 52 may share part of or all of the HMI 30 described above. For example, the route determination unit 53 determines, with reference to the first map information 54, a route from the position (or an input arbitrary position) of the vehicle M that is identified by the GNSS receiver 51 to a destination that is input by the occupant by using the navigation HMI 52. The first map information 54 is, for example, information in which a road shape is described by a link indicating a road and a node that is connected by the link. The first map information 54 may include the curvature of a road, POI (Point Of Interest) information, and the like. The route determined by the route determination unit 53 is output to the MPU 60. The navigation device 50 may perform a route guide using the navigation HMI 52 based on the route determined by the route determination unit 53. The navigation device 50 may be realized by, for example, a function of a terminal apparatus such as a smartphone and a tablet terminal held by a user. The navigation device 50 may transmit a current position and a destination to a navigation server via the communication device 20 and may acquire a route which is returned from the navigation server.

The MPU 60 functions, for example, as a recommended lane determination part 61. The MPU 60 holds second map information 62 in a storage device such as a HDD and a flash memory. The recommended lane determination part 61 divides the route that is supplied from the navigation device 50 into a plurality of blocks (for example, divides at an interval of 100 [m] with respect to a vehicle travel direction) and determines a recommended lane for each block with reference to the second map information 62. The recommended lane determination part 61 determines, for example, which lane from the left the vehicle should travel on. When a branching point, a merging point, or the like is present on the route, the recommended lane determination part 61 determines a recommended lane such that the vehicle M can travel on a reasonable travel route for proceeding to a branch destination.

The second map information 62 is map information having higher accuracy than the first map information 54. The second map information 62 includes, for example, information of the center of a lane, information of the boundary of a lane, or the like. The second map information 62 may include road information, traffic regulation information, address information (address and zip code), facility information, phone number information, and the like. The road information includes information representing the class of a road such as a freeway, a toll road, a national road, or a prefectural road and information of the lane number of a road, the region of an emergency parking area, the width of each lane, the gradient of a road, the position of a road (three-dimensional coordinate including the longitude, latitude, and height), the curvature of a curve of a lane, the position of merging and branching points of a lane, a sign provided on a road, and the like. The second map information 62 may be updated as needed by accessing another apparatus using the communication device 20.

The vehicle sensor 70 includes a vehicle speed sensor that detects the speed of the vehicle M, an acceleration sensor that detects acceleration, a yaw rate sensor that detects an angular speed around a vertical axis, an azimuth sensor that detects the direction of the vehicle M, and the like.

The driving operation element 80 includes, for example, an accelerator pedal, a brake pedal, a shift lever, a steering wheel, and other operation elements. A sensor that detects the amount of operation or the presence or absence of operation is attached to the driving operation element 80. A detection result of the sensor of the driving operation element 80 is output to one or both of the automated driving control unit 100, and the travel drive force output device 200, the braking device 210, and the steering device 220.

The vehicle interior camera 90 captures an image of an upper body centered at a face of the occupant seated on the driver seat. The capture image of the vehicle interior camera 90 is output to the automated driving control unit 100.

[Automated Driving Control Unit]

The automated driving control unit 100 includes, for example, a first control part 120 and a second control part 130. Each of the first control part 120 and the second control part 130 is realized by executing a program (software) by a processor such as a CPU (Central Processing Unit). Part of or all of functional parts of the first control part 120 and the second control part 130 described below may be realized by hardware such as a LSI (Large-Scale Integration), an ASIC (Application-Specific Integrated Circuit), and a FPGA (Field-Programmable Gate Array) or may be realized by the cooperation of software and hardware. The automated driving control unit 100 holds a set information table 141 and change history information 142 in a storage device such as a HDD and a flash memory.

In the first embodiment, a unit that includes part of or all of an outside recognition unit 121, a vehicle position recognition unit 122, and an action plan generation unit 123 of the first control part 120 described below and a travel control unit 131 of the second control part 130 is an example of a “travel assist control unit”.

The first control part 120 includes, for example, an outside recognition unit 121, a vehicle position recognition unit 122, an action plan generation unit 123, and an interface control unit 124.

The outside recognition unit 121 recognizes a state of the position, speed, acceleration, and the like of a peripheral vehicle based on information that is input via the object recognition device 16 from the camera 10, the radar device 12, and the finder 14. The position of a peripheral vehicle may be represented by a representative point such as a center of gravity or a corner of the peripheral vehicle or may be represented by a region described by the outline of the peripheral vehicle. The “state” of a peripheral vehicle may include the acceleration, jerk, or “action state” (for example, whether or not the peripheral vehicle is changing a lane, or whether or not the peripheral vehicle will change a lane) of the peripheral vehicle.

The outside recognition unit 121 may recognize positions of a guardrail, a power pole, a parked vehicle, a pedestrian, and other objects in addition to a peripheral vehicle.

The vehicle position recognition unit 122 recognizes, for example, the lane (travel lane) on which the vehicle M is travelling, and the relative position and attitude of the vehicle M with respect to the travel lane. The vehicle position recognition unit 122 recognizes the travel lane, for example, by comparing a pattern (for example, an arrangement of a solid line and a dashed line) of a road partition line that is obtained from the second map information 62 to a pattern of a road partition line in the vicinity of the vehicle M that is recognized from the image captured by the camera 10. In this recognition, the position of the vehicle M that is acquired from the navigation device 50 and the process result by the INS may be additionally considered.

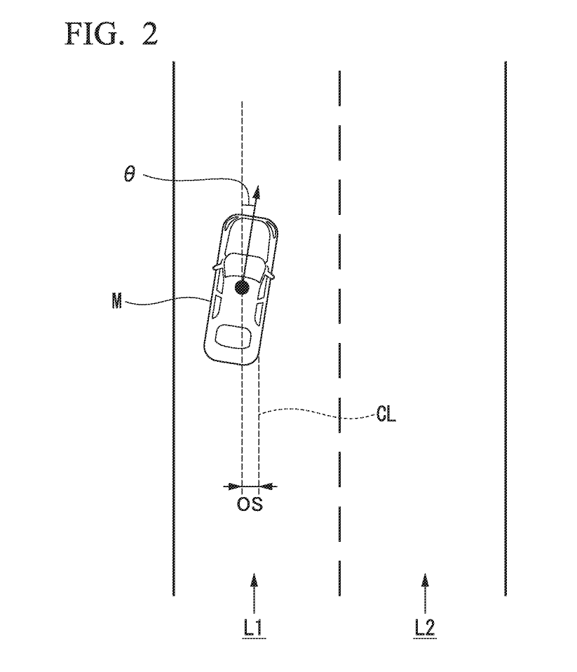

Then, the vehicle position recognition unit 122 recognizes, for example, the position and the attitude of the vehicle M with respect to the travel lane. FIG. 2 is a view showing a state in which the relative position and the attitude of the vehicle M with respect to a travel lane L1 are recognized by the vehicle position recognition unit 122. For example, the vehicle position recognition unit 122 recognizes, as the relative position and the attitude of the vehicle M with respect to the travel lane L1, a gap OS of a reference point (for example, the center of gravity) of the vehicle M from a travel lane center CL and an angle θ formed by the travel direction of the vehicle M with respect to a line formed of the continued travel lane centers CL. Alternatively, the vehicle position recognition unit 122 may recognize, as the relative position of the vehicle M with respect to the travel lane, the position of the reference point of the vehicle M with respect to any of side end parts of the travel lane L1 and the like. The relative position of the vehicle M that is recognized by the vehicle position recognition unit 122 is supplied to the recommended lane determination part 61 and the action plan generation unit 123.

[Action Plan Generation]

The action plan generation unit 123 generates an action plan for the vehicle M to perform automated driving to a destination and the like. For example, the action plan generation unit 123 determines events that are sequentially performed in an automated driving control so as to travel on the recommended lane that is determined by the recommended lane determination part 61 and so as to be capable of responding to peripheral circumstances of the vehicle M. Examples of the event in the automated driving of the first embodiment include a constant speed travel event of traveling on the same travel lane at a constant speed, a lane change event of changing the travel lane of the vehicle M, an overtaking event of overtaking a frontward traveling vehicle, a merging event that causes the vehicle to merge at a merging point, a branching event that causes the vehicle M to travel to a target direction at a branching point of a road, an emergency stop event that causes the vehicle M to stop urgently, a switching event (takeover event) for finishing automated driving and switching to manual driving, and the like. Further, an action for avoidance may be planned based on peripheral circumstances (presence of a peripheral vehicle or a pedestrian, lane narrowing due to a roadwork, and the like) of the vehicle M while performing the events.

The action plan generation unit 123 generates a target trajectory on which the vehicle M will travel. The target trajectory is, for example, information in which, at each predetermined sampling time (for example, about several hundred milliseconds), a target speed and target acceleration of the vehicle M at the sampling time are determined. Hereinafter, the target point to be arrived at each sampling time is represented schematically as a set of a point sequence (trajectory point). The position of the target point at which the vehicle M should arrive at each sampling time is not necessarily matched to the position of the trajectory point that represents the target point. For example, when the speed of the vehicle M is decreased, the spacing between target points at each sampling time is gradually narrowed, but the trajectory point that represents the target point may be represented at a constant spacing.

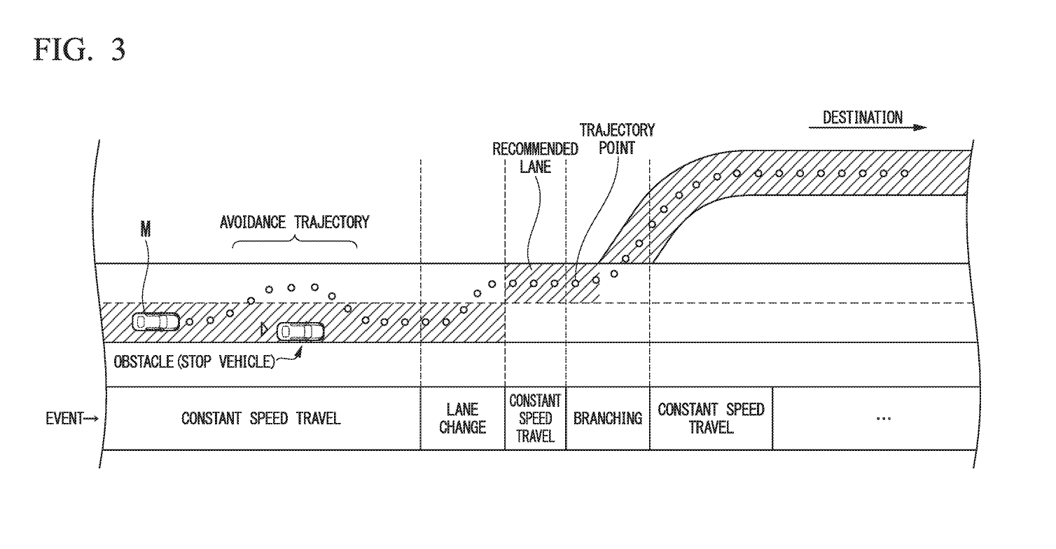

FIG. 3 is a view showing a state in which a target trajectory is generated based on a recommended lane. As shown in FIG. 3, the recommended lane is set such that it is convenient to travel along a route to a destination.

When arriving at a position (the position may be determined corresponding to the category of an event) by a predetermined distance before a position at which the recommended lane is switched, the action plan generation unit 123 starts a lane change event, a branching event, a merging event, and the like. When it becomes necessary to avoid an obstacle while performing the events, an avoidance trajectory is generated as shown in FIG. 3.

The action plan generation unit 123 generates, for example, a plurality of candidates of the target trajectory and selects an optimum target trajectory that fits the route to the destination at the time point based on a point of view of safety and efficiency. The action plan generation unit 123 may generate information relating to the timing when a setting to a specific event that is being performed can be changed from a point of view of safety and efficiency of travel assist of the vehicle M.

[Interface Control]

The interface control unit 124 generates a menu which enables a change of setting by the occupant of the vehicle M in relation to an event which is being performed by the action plan generation unit 123 and causes the HMI 30 to present the generated menu in a mode of a screen display, a speech output, or the like.

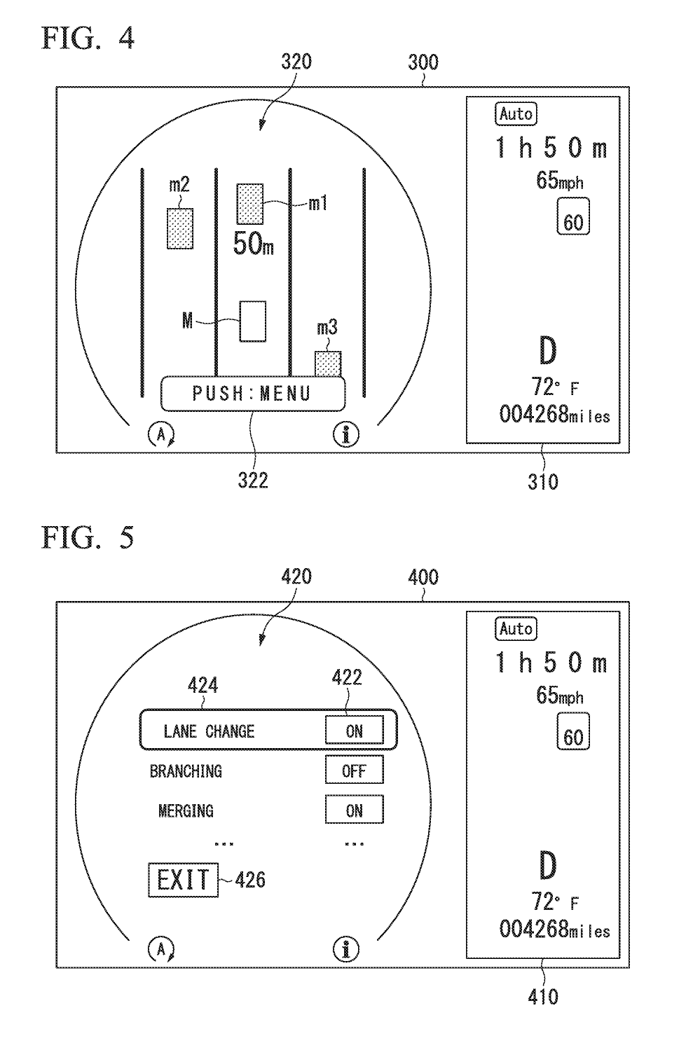

FIG. 4 is a view showing an example of a display screen 300 that is presented on the touch panel 31 by a control of the interface control unit 124. The display screen 300 shown in FIG. 4 has, for example, a travel information display region 310 and a travel state display region 320.

The interface control unit 124 causes the travel information display region 310 to include information relating to a variety of information regarding the travel of the vehicle M and the like. Examples of the information included in the travel information display region 310 include a drive mode (automated driving or manual driving) of the vehicle M, a travel time to a destination, a vehicle speed, a regulation speed of a travel road, a shift position, an external air temperature, a travel distance, and the like.

The interface control unit 124 causes the travel state display region 320 to include information relating to an environmental state of the vehicle M and the like. Examples of the information included in the travel state display region 320 include a map image around the vehicle M that is acquired from the second map information 62 with reference to the current position of the vehicle M, an image associated with the vehicle M, and images associated with peripheral vehicles ml to m3.

The interface control unit 124 sets, in the travel state display region 320, a GUI switch 322 used for including a menu screen which enables a change of setting by the occupant of the vehicle M in relation to an event which is being performed by the vehicle M. The occupant touches the displayed GUI switch 322 or performs a predetermined operation to another predetermined physical switch 33 and the like, and thereby, the menu screen which enables a change of setting by the occupant of the vehicle M in relation to the event which is being performed is displayed.

FIG. 5 is a view showing an example of a menu screen 400 that is displayed on the touch panel 31. The menu screen 400 is a screen that is displayed on the touch panel 31 by operating the GUI switch 322.

The menu screen 400 has, for example, a travel information display region 410 and a customizing menu display region 420. In the travel information display region 410, a similar content as that in the travel information display region 310 is displayed.

The interface control unit 124 displays, in the customizing menu display region 420, for example, a pair of an event of which the setting can be changed at a current time point and part of or all of set information with respect to each event. The set information with respect to each event can be acquired from the set information table 141 in the automated driving control unit 100.

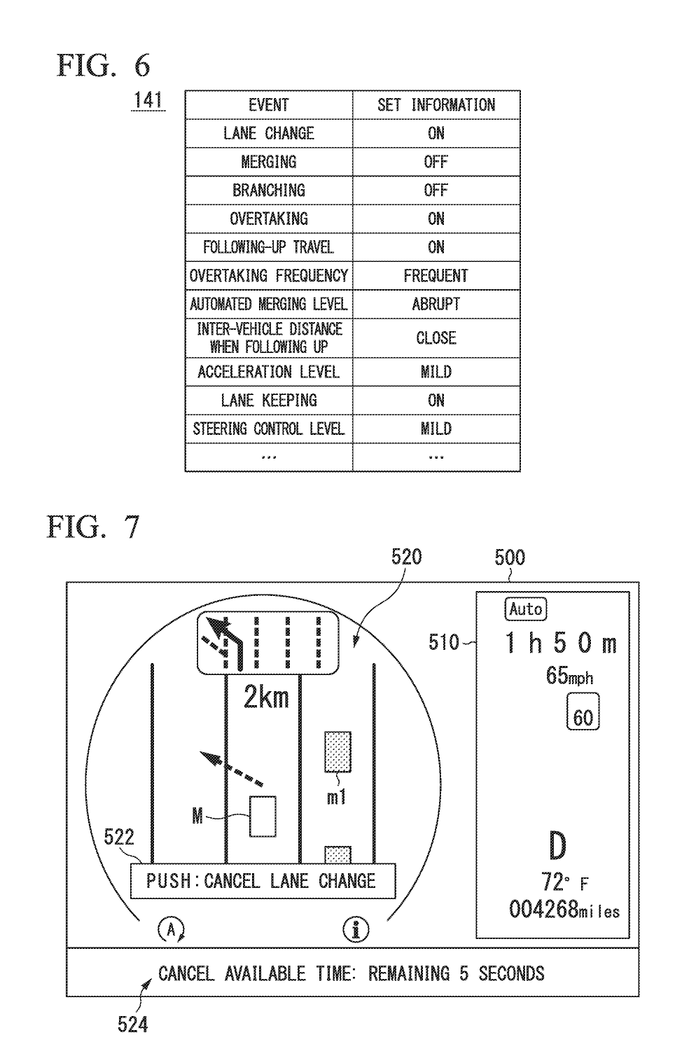

FIG. 6 is a view showing an example of the set information table 141. In the set information table 141, for example, set information is associated with an event relating to the automated driving control.

In the set information table 141, information indicating whether or not each event is performed, which is an example of the set information, is associated with, for example, a plurality of events that are performable as the automated driving control of the vehicle M. In FIG. 6, “ON” indicates that an event is performed, and “OFF” indicates that an event is not performed.

In the set information table 141, information relating to the degree of performance of each event may be stored as the set information. The information relating to the degree of performance of the event is, for example, information relating to a performance frequency (frequent, not frequent) of an event, information relating to an event performance level (whether abrupt merging is performed or only moderate merging is performed), and information relating to the degree of an inter-vehicle distance (whether the distance to a frontward traveling vehicle is large or small), an on/off of lane keeping, and the degree of a steering control level, and the like.

Part of or all of an event of which the setting can be changed by the occupant and set information with respect to the event are acquired by the interface control unit 124 from the set information table 141 and are included in the customizing menu display region 420. In this case, as shown in FIG. 5, the interface control unit 124 may set a GUI switch 422 that shows a pair of each event and set information.

When one of the GUI switches 422 that correspond to a plurality of events which are displayed on the menu screen 400 is selected by the occupant, the interface control unit 124 commands the action plan generation unit 123 to switch between performing the selected event and not performing the selected event. When one of the GUI switches 422 is selected, the interface control unit 124 may command the action plan generation unit 123 to switch between the degrees of performance of the selected event. In this case, the interface control unit 124 causes a display region of the GUI switch 422 to include set information of an event that is switched by the action plan generation unit 123.

The interface control unit 124 may output whether or not an event is performed by the GUI switch 422. When the degree of performance of the event is switched, the interface control unit 124 may output speech indicating that the degree of performance of the event is switched by the speaker 32.

When a selection operation is performed by a method other than the touch panel 31, the interface control unit 124 may allow a selection frame 424 that indicates an event which is selected at that time point among events which are displayed in the customizing menu display region 420 to be included in the customizing menu display region 420. The interface control unit 124 may allow the event which is selected at that time point to be displayed on the touch panel 31 using a different color from a color by which another event is displayed.

As shown in FIG. 5, the interface control unit 124 may set a GUI switch 426 used for returning to the display screen 300 from the menu screen 400. When the GUI switch 426 is selected, the interface control unit 124 causes the touch panel 31 to display the display screen 300. When there is no operation from the occupant for a predetermined period of time or more after the menu screen 400 is displayed on the touch panel 31, the interface control unit 124 may switch the screen to the display screen 300.

When the GUI switch 322 used for displaying the menu screen 400 is selected, the interface control unit 124 not only may cause the menu screen 400 to be displayed but also, at the timing when an event is performed by the action plan generation unit 123 (more specifically, at the timing when starting to perform the event, or a timing before or after the starting timing), may display the event and a real-time change-accepting screen that accepts a command of a change of setting with respect to the event on the touch panel 31.

FIG. 7 is a view showing an example of a real-time change-accepting screen that is displayed when performing an event. A real-time change-accepting screen 500 shown in FIG. 7 has, for example, a travel information display region 510 and a travel state display region 520. In the travel information display region 510, a similar content as that in the travel information display region 310 is displayed. In the travel state display region 520, a similar content as that in the travel state display region 320 and information relating to a future target trajectory are displayed.

The interface control unit 124 sets a GUI switch 522 used for canceling a lane change event at the timing when a lane change event is performed by the action plan generation unit 123. The interface control unit 124 may cause the speaker 32 to output speech indicating that the GUI switch 522 is displayed in the travel state display region 520.

The interface control unit 124 may allow the real-time change-accepting screen 500 to include information relating to a remaining time in which the lane change event can be canceled. In the example of FIG. 7, the interface control unit 124 may generate an image 524 that indicates a remaining time in which cancellation is available and may allow the generated image 524 to be included in the real-time change-accepting screen 500. The remaining time in which cancellation is available is, for example, a value obtained by dividing a distance between the current position of the vehicle M and a position where the center of gravity or the like of the vehicle M passes a road partition line by the speed of the vehicle M. The interface control unit 124 may allow an image indicating a remaining distance between the current position of the vehicle M and a position where the center of gravity or the like of the vehicle M passes a road partition line to be included in the real-time change-accepting screen 500 in place of or in addition to the remaining time in which cancellation is available. Thereby, the occupant can further clearly understand the timing in which the displayed event can be canceled and can determine the necessity of performing the event easily within a period of time in which the displayed event can be canceled.

When the GUI switch 522 that is displayed on the real-time change-accepting screen 500 is selected by the occupant, the action plan generation unit 123 cancels the lane change event that is being performed and generates a new target trajectory.

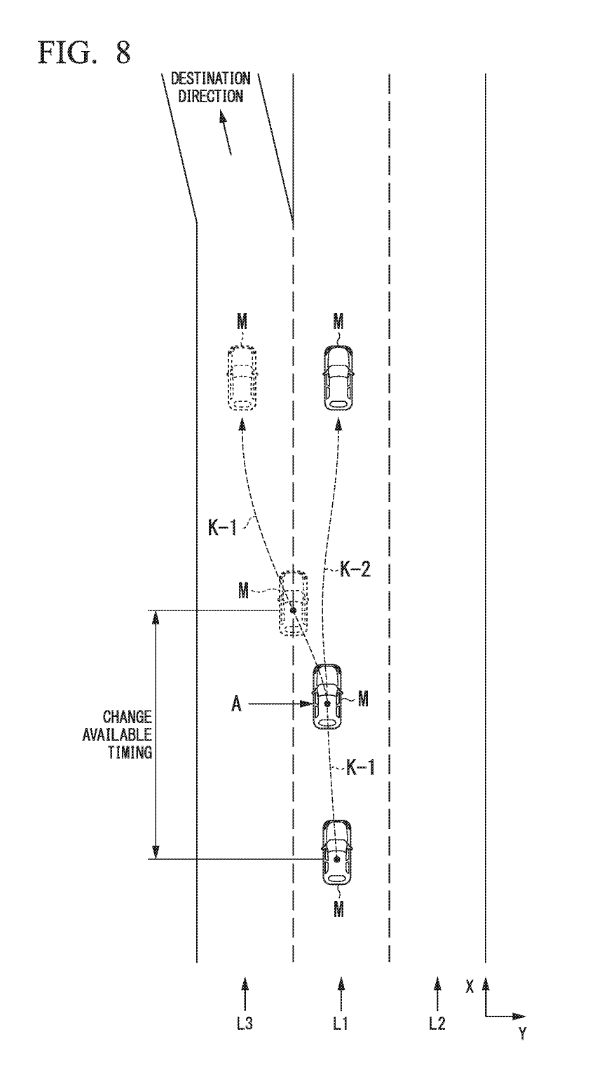

FIG. 8 is a view showing an example of a target trajectory that is generated by the action plan generation unit 123 when a lane change event which is being performed is canceled. For example, as shown in FIG. 8, it is assumed that the vehicle M is traveling on a target trajectory K-1 for the vehicle M to perform a lane change from a travel lane L1 to a lane L3, and a cancel command of a lane change event is accepted at a time point when the vehicle M passes a point A.

The point A is included in a range of the timing when the change of the lane change event is available. Accordingly, the action plan generation unit 123 generates a target trajectory K-2 used for traveling while keeping the current travel lane from the current position (position A) of the vehicle M and causes the vehicle M to travel along the generated target trajectory K-2. When accepting a cancel command of the lane change at a timing which is other than the change available timing, the action plan generation unit 123 continues performing the lane change event which is being performed and causes the vehicle M to travel along the target trajectory K-1.

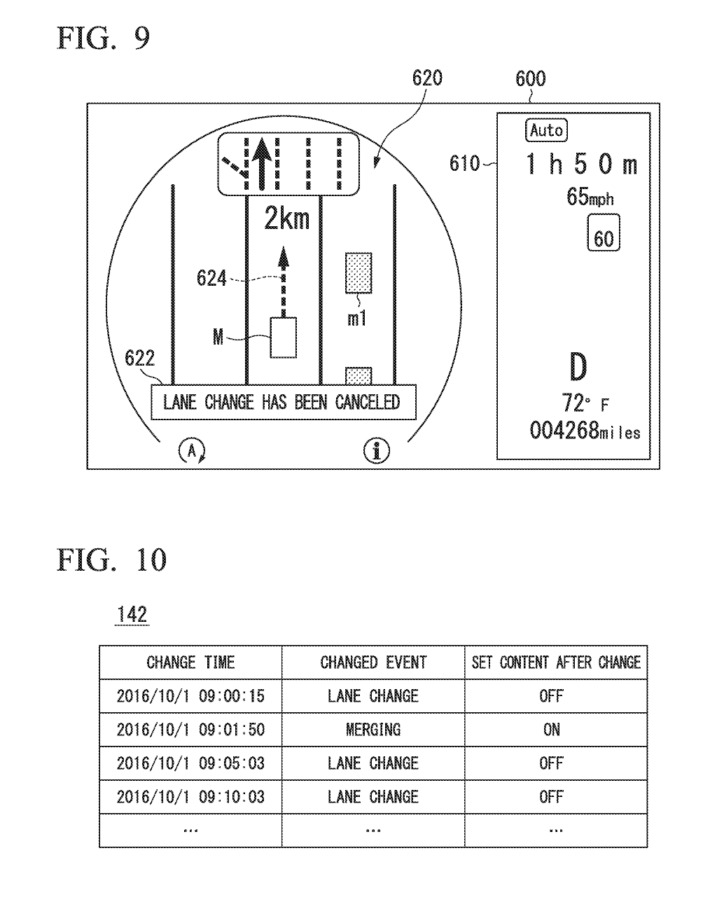

When the GUI switch 522 is operated, and the lane change event is cancelled, the interface control unit 124 causes an image indicating that the lane change event is canceled to be included in a display screen of the touch panel 31. FIG. 9 is a view showing an example of a display screen 600 when the lane change event is canceled.

The display screen 600 has, for example, a travel information display region 610 and a travel state display region 620. In the travel information display region 610, a similar content as that in the travel information display region 310 is displayed. In the travel state display region 620, a similar content as that in the travel state display region 520 is displayed.

When accepting a cancel command of the lane change, the interface control unit 124 causes an image 622 indicating that the lane change event is canceled to be included in the display screen 600. Further, the interface control unit 124 causes an image 624 indicating a travel trajectory of the vehicle M based on the target trajectory K-2 which is newly generated to be included in the display screen 600.

The interface control unit 124 may cause the image 622 to be included in the display screen 600 and may cause the speaker 32 to output speech indicating that the lane change event is canceled. The interface control unit 124 may delete the image 622 included in the display screen 600 after a predetermined period of time has elapsed.

When a change of setting with respect to an event which is being performed is performed by the process described above, the interface control unit 124 stores the changed set information in the change history information 142. FIG. 10 is a view showing an example of the change history information 142. In the change history information 142, for example, a change time and a set content after the change are associated with each changed event.

The interface control unit 124 refers to the change history information 142 at a predetermined timing and determines whether or not there is an event for which a command of the same change of setting is accepted a plurality of times in a predetermined period of time. The predetermined timing may be, for example, the timing when the content of the event of which the setting is changed is stored to the change history information 142 or may be the timing at each unit time. The plurality of times means the number of times which is arbitrarily set to two or more.

For example, the interface control unit 124 refers to the change history information 142 and determines whether or not there is an event for which a command of the same change of setting is accepted a predetermined number of times (for example, three times and the like) in one hour. In the example shown in FIG. 10, the lane change event is the event described above. In this case, the interface control unit 124 causes the touch panel 31 to display a screen for inquiring about whether or not set information of the lane change event that is stored in the set information table 141 is updated to a content to be changed by the command.

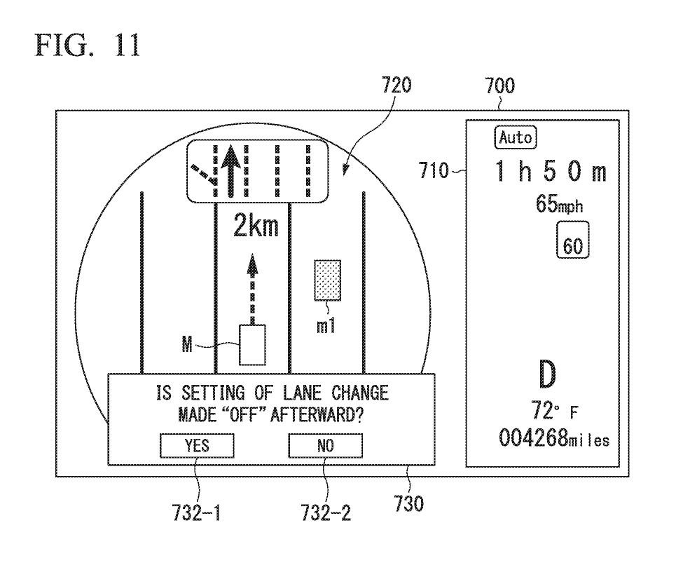

FIG. 11 is a view showing an example of a screen for inquiring about whether or not set information of the event is updated. A display screen 700 shown in FIG. 11 corresponds to the display screen 600 described above. Accordingly, in the travel information display region 710, a similar content as that in the travel information display region 610 is displayed, and in the travel state display region 720, a similar content as that in the travel state display region 620 is displayed.

The interface control unit 124 causes an inquiry screen 730 for inquiring whether or not set information of the lane change event that is stored in the set information table 141 is updated to set information to be changed by the command to be included in the travel state display region 720. The interface control unit 124 may cause the speaker 32 to output speech indicating that the inquiry screen 730 is displayed on the touch panel 31.

The interface control unit 124 sets, in the inquiry screen 730, a “YES” GUI switch 732-1 and a “NO” GUI switch 732-2 that allow to determine whether or not the setting of the lane change event is made “OFF” afterward. When the “YES” GUI switch 732-1 is selected by the occupant, the interface control unit 124 updates the set information of the lane change event that is stored in the set information table 141 from “ON” to “OFF”. On the other hand, when the “NO” GUI switch 732-2 is selected by the occupant, the interface control unit 124 does not update the set information table 141. In this way, by responding to the inquiry by the inquiry screen 730 about whether or not the set information is to be changed, the occupant can customize automated driving corresponding to the preference of the occupant.

The second control part 130 includes, for example, a travel control unit 131 and a switch control unit 132. The travel control unit 131 controls the travel drive force output device 200, the braking device 210, and the steering device 220 such that the vehicle M passes through the target trajectory that is generated by the action plan generation unit 123 exactly at a scheduled time.

The switch control unit 132 switches the vehicle M from automated driving to manual driving, for example, based on an operation to command acceleration, deceleration, or steering to the driving operation element 80 such as an acceleration pedal, a brake pedal, and a steering wheel.

The travel drive force output device 200 outputs, to a drive wheel, a travel drive force (torque) by which the vehicle travels. The travel drive force output device 200 includes, for example, the combination of an internal combustion engine, an electric motor, a transmission, and the like and an ECU (Electronic Control Unit) that controls the internal combustion engine, the electric motor, the transmission, and the like. The ECU controls the above configuration in accordance with information input from the travel control unit 131 or information input from the driving operation element 80.

The braking device 210 includes, for example, a brake caliper, a cylinder that transmits an oil pressure to the brake caliper, an electric motor that generates the oil pressure at the cylinder, and a brake ECU. The brake ECU controls the electric motor, in accordance with the information input from the travel control unit 131 or the information input from the driving operation element 80, to output a braking torque corresponding to a braking operation to each wheel. The braking device 210 may include, as a backup, a mechanism that transmits, to the cylinder via a master cylinder, an oil pressure generated by an operation of the brake pedal included in the driving operation element 80. The braking device 210 is not limited to the configuration described above and may be an electronically-controlled hydraulic braking device that controls an actuator in accordance with the information input from the travel control unit 131 and transmits the oil pressure of the master cylinder to the cylinder. The braking device 210 may include a plurality of braking device systems in consideration of safety.

The steering device 220 includes, for example, a steering ECU and an electric motor.

For example, the electric motor applies a force to a rack and pinion mechanism and changes the direction of a steering wheel. The steering ECU drives the electric motor and changes the direction of the steering wheel in accordance with the information input from the travel control unit 131 or the information input from the driving operation element 80.

[Vehicle Control Process] Next, a process content when a variety of processes in the first embodiment described above are executed by a program installed in an in-vehicle computer of the vehicle M is described using a flowchart.

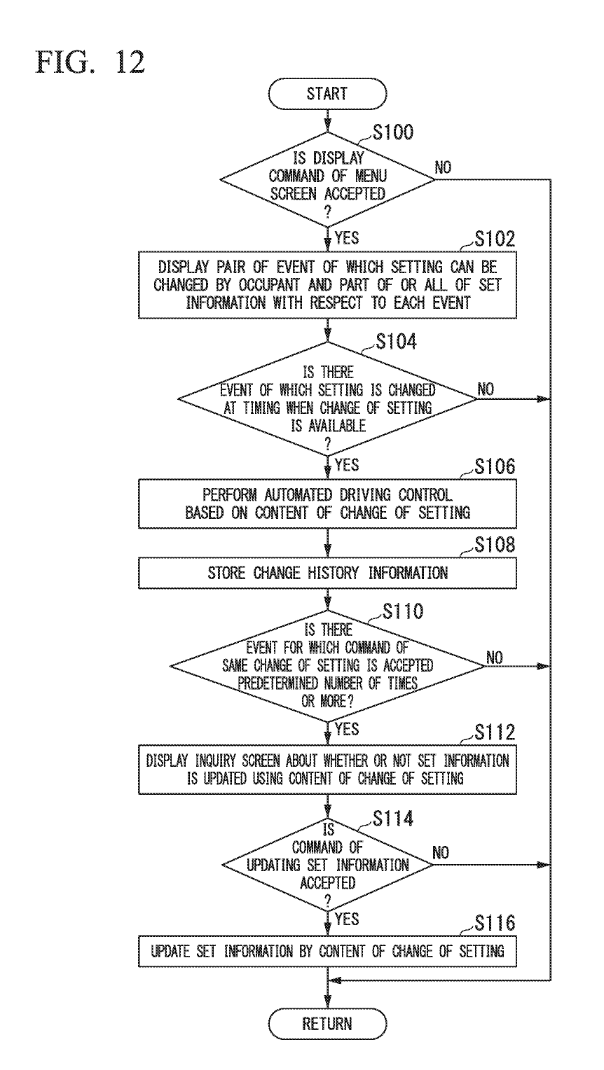

FIG. 12 is a flowchart showing an example of a vehicle control process of the first embodiment. The process of FIG. 12 is performed, for example, repeatedly while performing an automated driving control.

The interface control unit 124 determines whether or not a display command of a menu screen that displays an event of which the setting can be changed by the occupant is accepted (Step S100). When a display command of the menu screen is accepted, the interface control unit 124 causes the touch panel 31 to display a pair of an event of which the setting can be changed by the occupant in the automated driving control at the current time point of the vehicle M and part of or all of set information with respect to each event (Step S102).

Next, the interface control unit 124 determines whether or not there is an event of which the setting is changed at the timing when the change of setting is available among set information displayed on the touch panel 31 (Step S104). When there is an event of which the setting is changed, the action plan generation unit 123 performs an automated driving control based on the content of the change of setting (Step S106). Next, the interface control unit 124 stores the content of the change of setting in the change history information 142 (Step S108).

Next, the interface control unit 124 determines whether or not there is an event for which a command of the same change of setting is accepted a predetermined number of times (for example, three times) or more in a predetermined period of time (Step S110). When there is an event for which a command of the same change of setting is accepted a predetermined number of times or more, the interface control unit 124 causes the touch panel 31 to display an inquiry screen about whether or not the event is updated to the content of the change of setting (Step S112). Next, the interface control unit 124 determines whether or not a command of updating the set information is accepted (Step S114). When a command of updating the set information is accepted, the interface control unit 124 updates the set information by the content of the change of setting (Step S116) and finishes the process of the present flowchart.

When a display command of the menu screen is not accepted in the process of Step S100, or when there is not an event of which the setting is changed in the process of Step S104, the interface control unit 124 finishes the process of the present flowchart. When there is not an event for which a command of the same change of setting is accepted a predetermined number of times or more in the process of Step S110, or when a command of updating the set information is not accepted in Step S114, the interface control unit 124 finishes the process of the present flowchart.

In the example of FIG. 12, the interface control unit 124 causes the touch panel 31 to display a menu used for changing information with respect to an event that can be changed by the occupant at a time point when accepting a display command of the menu screen; however, the interface control unit 124 may cause the touch panel 31 to display, at a timing when an event is performed, a menu screen that accepts a command of the change of setting with respect to the event.

According to the vehicle control system, the vehicle control method, and the vehicle control program in the first embodiment described above, it is possible to guide an occupant so as to easily perform a change of setting relating to automated driving in an event that is performed in an automated driving control of the vehicle M. Accordingly, the occupant can perform a flexible change of setting while performing automated driving and can perform a change of setting at an appropriate timing. Further, according to the first embodiment, by displaying information relating to the timing when the change of setting of an event is available, the occupant can perform the setting of the event easily.

Further, according to the first embodiment, when there is an event for which the same change of setting is accepted a plurality of times, by inquiring about whether the set information of the event is to be updated, it is possible to customize automated driving corresponding to the preference of each occupant.

### Second Embodiment

Next, a vehicle control system, a vehicle control method, and a vehicle control program of a second embodiment are described. In the second embodiment, the vehicle control system is applied to a travel assist driving vehicle. The travel assist refers to, for example, performing travel assist for keeping the current travel state of the vehicle M or performing travel assist for detecting in advance and avoiding a possibility of an accident of the vehicle M and the like in manual driving by the occupant.

[Entire Configuration]

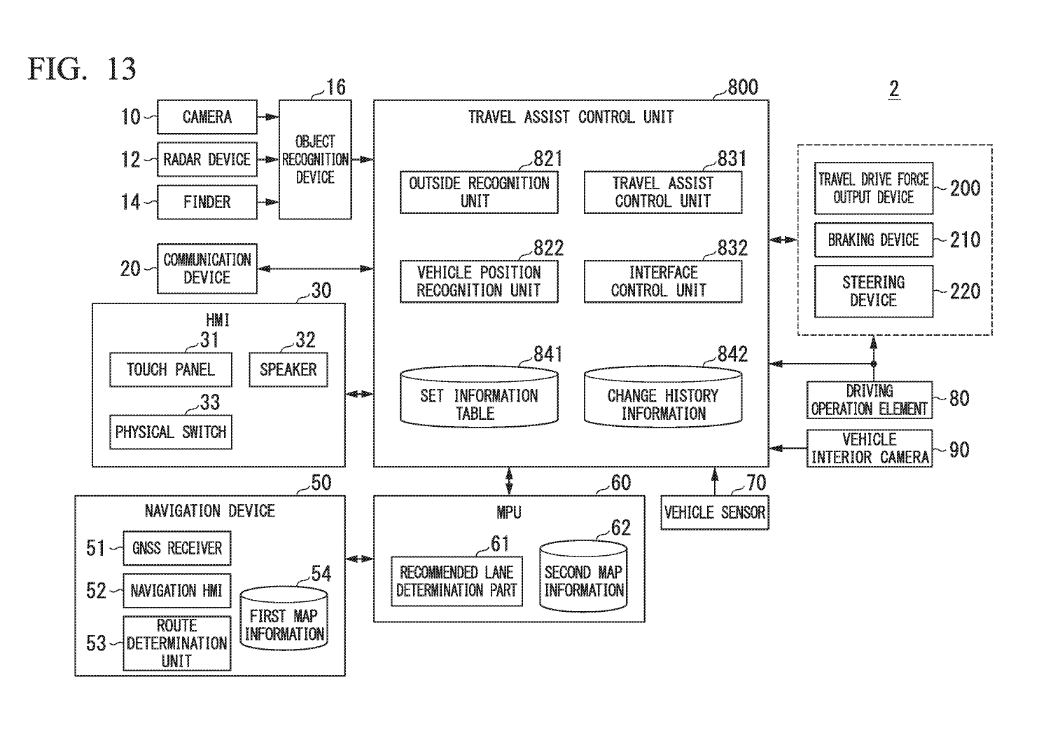

FIG. 13 is a configuration view of a vehicle system 2 of a second embodiment. In the following description, the same name and reference sign are given to a configuration of the vehicle system 2 having a similar function to that of the vehicle system 1 in the first embodiment, and specific description of the configuration is omitted.

The vehicle system 2 includes, for example, a camera 10, a radar device 12, a finder 14, an object recognition device 16, a communication device 20, a HMI 30, a navigation device 50, a MPU 60, a vehicle sensor 70, a driving operation element 80, a vehicle interior camera 90, a travel assist control unit 800, a travel drive force output device 200, a braking device 210, and a steering device 220. These devices and equipment are mutually connected by a multiplex communication line such as a CAN communication line, a serial communication line, a wireless communication network, and the like. The configuration shown in FIG. 13 is just an example. Part of the configuration may be omitted, and another configuration may be further added.

The travel assist control unit 800 in place of the automated driving control unit 100 is provided on the vehicle system 2 in comparison with the vehicle system 1 of the first embodiment described above. The travel assist control unit 800 is mainly described in the following description.

[Travel Assist Control Unit]

The travel assist control unit 800 includes, for example, an outside recognition unit 821, a vehicle position recognition unit 822, a travel assist control unit 831, an interface control unit 832, a set information table 841, and change history information 842. The configuration of the travel assist control unit 800 may include a part which is not essential and may be appropriately omitted. Each of the outside recognition unit 821, the vehicle position recognition unit 822, the travel assist control unit 831, and the interface control unit 832 is realized by executing a program by a processor such as a CPU. Part of or all of functional parts may be realized by hardware such as a LSI, an ASIC, and a FPGA or may be realized by the cooperation of software and hardware. In the second embodiment, for example, a “vehicle control system” includes the HMI 30 and the travel assist control unit 800.

The outside recognition unit 821 includes a function similar to that of the outside recognition unit 121 of the automated driving control unit 100. The function of the outside recognition unit 821 may be a more limited function than the function of the outside recognition unit 121. The vehicle position recognition unit 822 includes a function similar to that of the vehicle position recognition unit 122 of the automated driving control unit 100. The function of the vehicle position recognition unit 822 may be a more limited function than the function of the vehicle position recognition unit 122. The data structure of the set information table 841 is similar to the data structure of the set information table 141 of the automated driving control unit 100. The data structure of the change history information 842 is similar to the data structure of the change history information 142 of the automated driving control unit 100.

[Travel Assist Control]

The travel assist control unit 831 determines events that are sequentially performed in a travel assist control in manual driving of the vehicle M. The events performed in the travel assist control include, for example, a collision reduction braking event, an ACC (Adaptive Cruise Control System) event, a LDW (Lane-Departure Warning) event, a LKAS (Lane-Keeping Assistance System) event, and the like. The event in the travel assist may include a lane change event and the like.

For example, when the collision reduction braking event is performed, the travel assist control part 831 determines, from a detection result of an obstacle such as a frontward traveling vehicle of the vehicle M, an oncoming vehicle, and a pedestrian, a risk of collision with the obstacle. Then, when it is determined that there is a risk of collision, the travel assist control part 831 causes the interface control unit 832 to present information relating to the risk to the occupant. Further, when a risk avoidance control of the vehicle M is not performed by the occupant even after the information relating to the risk is presented, the travel assist control part 831 automatically reduces a travel drive force by the travel drive force output device 200 and performs a control such as braking by the braking device 210.

When the ACC event is performed, the travel assist control part 831 performs travel assist relating to an acceleration/deceleration control and the like so as to keep the inter-vehicle distance between the vehicle M and a frontward traveling vehicle constant. When the LDW event is performed, the travel assist control part 831 causes the HMI 30 to present, before the vehicle M will be deviated from the travel lane, information indicating that the vehicle M will be deviated from the travel lane in a mode such as a screen display and a speech output. When the LKAS event is performed, the travel assist control part 831 performs a steering control by the steering device 220 and causes the vehicle M to travel while maintaining the current travel lane (lane keeping).

When accepting a change of setting of an event from a menu screen displayed on the touch panel 31 by a control of the interface control unit 832 at a timing when a change of setting is available, the travel assist control part 831 performs travel assist in which whether or not the event is performed or travel assist that switches between the degrees of performance of the event.

[Interface Control]

The interface control unit 832 generates a menu which enables a change of setting by the occupant of the vehicle M in relation to an event which is being performed by the travel assist control part 831 and causes the HMI 30 to present the generated menu in a mode of a screen display, a speech output, or the like. With respect to a control that causes the HMI 30 to present the menu in the interface control unit 832, a process similar to that of the interface control unit 124 is performed, and therefore, specific description is omitted.

Set information with respect to each event displayed on the menu screen can be acquired from the set information table 841. In this case, set information of each event relating to the travel assist control described above (information relating to whether or not the event is performed or the degree of performance of each event) is stored in the set information table 841.

The interface control unit 832 causes an event of which the setting can be changed by the occupant while performing travel assist to be included in the menu screen from the events stored in the set information table 841. The interface control unit 832 may cause the touch panel 31 to display, at the timing when an event is performed by the travel assist control part 831 (more specifically, at the timing when starting to perform the event, or a timing before or after the starting timing), the event and a real-time change-accepting screen that accepts a command of a change of setting with respect to the event.

When accepting a change of setting of an event from the menu screen or the real-time change-accepting screen at the timing when a change of setting is available, the interface control unit 832 causes information relating to the event of which the setting is changed to be stored in the change history information 842.

The interface control unit 832 refers to the change history information 842 and determines whether or not there is an event for which a command of the same change of setting is accepted a plurality of times in a predetermined period of time. When there is an event for which a command of the same change of setting is accepted a plurality of times in a predetermined period of time, the interface control unit 832 causes the touch panel 31 to display a screen that inquires whether or not set information of the event that is stored in the set information table 841 is updated to the content of the change command. When accepting a command to update set information from the screen, the interface control unit 832 updates the set information of the same event that is stored in the set information table 841 to the content of the change command.

[Vehicle Control Process]

A vehicle control process in the second embodiment can be described, for example, by the vehicle control process in the first embodiment described above which appropriately replaces the “automated driving control” by the “travel assist control”, replaces the “action plan generation unit 123” by the “travel assist control unit 831”, and replaces the “interface control unit 124” by the “interface control unit 832”, and therefore, specific description of the vehicle control process in the second embodiment is omitted.

According to the vehicle control system, the vehicle control method, and the vehicle control program in the second embodiment described above, it is possible to guide an occupant so as to easily perform a change of setting relating to travel assist in an event that is performed in a travel assist control of the vehicle M. Accordingly, the occupant can perform a flexible change of setting while performing travel assist and can perform a change of setting at an appropriate timing. Part of or all of the first and second embodiments in the vehicle control described above may be combined.

Although the embodiments of the invention have been described with reference to the drawings, the invention is not limited to the embodiments described above, and a variety of changes and substitution can be added without departing from the scope of the invention.

What is claimed is:

1. A vehicle control system, comprising:
a travel assist control unit that performs an event which relates to a travel assist control of a vehicle;
an interface unit that accepts an operation of an occupant of the vehicle and displays an image; and
an interface control unit that controls the interface unit so as to present a menu which enables a change of setting by the occupant of the vehicle in relation to an event which is being performed by the travel assist control unit.

2. The vehicle control system according to claim 1,
wherein in a case where the event which is being performed by the travel assist control unit is a specific event, when accepting a command to cancel performing the specific event, the interface control unit commands the travel assist control unit to cancel performing the event.

3. The vehicle control system according to claim 1,
wherein in a case where there is an event for which a change of setting by the occupant is accepted a plurality of times, the interface control unit inquires the occupant about whether or not set information of the event is to be changed using the interface unit.

4. The vehicle control system according to claim 2,
wherein in a case where there is an event for which a change of setting by the occupant is accepted a plurality of times, the interface control unit inquires the occupant about whether or not set information of the event is to be changed using the interface unit.

5. The vehicle control system according to claim 1,
wherein the interface control unit causes the interface unit to present information relating to at least one of a remaining time and a remaining distance in which a change of setting can be made by the occupant of the vehicle regarding the event which is being performed by the travel assist control unit.

6. The vehicle control system according to claim 2,
wherein the interface control unit causes the interface unit to present information relating to at least one of a remaining time and a remaining distance in which a change of setting can be made by the occupant of the vehicle regarding the event which is being performed by the travel assist control unit.

7. The vehicle control system according to claim 3,
wherein the interface control unit causes the interface unit to present information relating to at least one of a remaining time and a remaining distance in which a change of setting can be made by the occupant of the vehicle regarding the event which is being performed by the travel assist control unit.

8. The vehicle control system according to claim 4,
wherein the interface control unit causes the interface unit to present information relating to at least one of a remaining time and a remaining distance in which a change of setting can be made by the occupant of the vehicle regarding the event which is being performed by the travel assist control unit.

9. A vehicle control method, by way of an in-vehicle computer, comprising:
performing an event which relates to a travel assist control of a vehicle;
accepting an operation of an occupant of the vehicle and displaying an image on an interface unit; and
controlling the interface unit so as to present a menu which enables a change of setting by the occupant of the vehicle in relation to an event which is being performed.

10. A non-transitory computer-readable recording medium comprising a vehicle control program that causes an in-vehicle computer to:
perform an event which relates to a travel assist control of a vehicle;
accept an operation of an occupant of the vehicle and display an image on an interface unit; and
control the interface unit so as to present a menu which enables a change of setting by the occupant of the vehicle in relation to an event which is being performed.
